(19) United States
(12) Patent Application Publication
(10) Pub. No.: US 2008/0203137 A1
(43) Pub. Date: Aug. 28, 2008

(54) SUBSTRATE BONDING METHODS AND SYSTEM INCLUDING MONITORING

(75) Inventors: Douglas C. La Tulipe, New Fairfield, CT (US); Steven E. Steen, Peekskill, NY (US); Anna W. Topol, Wappingers Falls, NY (US)

Correspondence Address: HOFFMAN WARNICK LLC, 75 State Street, 14th Floor, ALBANY, NY, 12207, US

(73) Assignee: International Business Machines Corporation, Armonk, NY (US)

(21) Appl. No.: 11/680,183

(22) Filed: Feb. 28, 2007

(51) Int. Cl. B23K 31/12

(52) U.S. Cl. 228/103; 73/588

(57) ABSTRACT

Bonding methods and a bonding system including monitoring are disclosed. In one embodiment, a method of monitoring bonding a first and second substrate includes: providing a plurality of piezoelectric sensors to a substrate mounting stage of a substrate bonding system; and monitoring a force change measured by the plurality of piezoelectric sensors induced by a bond front between the first and second substrate during bonding. This method allows real time monitoring of the bonding quality and adjustment of the bonding process parameters.

### BACKGROUND

1. Technical Field

The disclosure relates generally to integrated circuit (IC) fabrication, and more particularly, to a method of bonding two substrates including monitoring, and a related bonding system.

2. Background Art

In the integrated circuit (IC) fabrication industry, two wafer substrates may be bonded together by placing them in contact and applying pressure to force the two substrates to bond. Currently, there is no mechanism available to control and determine bonding quality in real-time. Post bonding examination is utilized using infra-red inspection. During the inspection of the bonded substrates (after the bonding process), inspection is performed to determine the existence of abnormalities such as voids, i.e., regions of un-bonded substrate that are created during the bonding process by encapsulation of gas by the bond front. One approach to addressing this problem is relieving or removing these areas by pulling the two substrates apart, which in some cases destroys the bonding surfaces. In an ideal bonding process, bonding starts from the center of both substrates and fusion bonding progresses outwardly. Unfortunately, due to the topography of the incoming substrates, bonding typically does not start in the center, but at multiple points at the same time, which increases the probability of air being trapped in the interface. Another approach to addressing this issue includes incorporating piezoelectric actuators on a stage to adjust the bonding, which can significantly enhance process control. However, the adjustment is a corrective action, i.e., after the bonding has occurred, which is not as effective compared to real time corrections.

### SUMMARY

Bonding methods and a bonding system including monitoring are disclosed. In one embodiment, a method of monitoring bonding a first and second substrate includes: providing a plurality of piezoelectric sensors to a substrate mounting stage of a substrate bonding system; and monitoring a force change measured by the plurality of piezoelectric sensors induced by a bond front between the first and second substrate during bonding. This method allows real time monitoring of the bonding quality and adjustment of the bonding process parameters.

A first aspect of the disclosure provides a method of monitoring bonding of a first and second substrate, the method comprising: providing a plurality of piezoelectric sensors to a substrate mounting stage of a substrate bonding system; and monitoring a force change measured by the plurality of piezoelectric sensors induced by a bond front between the first and second substrates during bonding.

A second aspect of the disclosure provides a method of bonding a first and second substrate, the method comprising: providing a plurality of piezoelectric sensors on a first substrate mounting stage of a substrate bonding system; mounting the first substrate to the first substrate mounting stage and the second substrate to a second substrate mounting stage; and bonding the first and second substrates while monitoring a force change measured by the plurality of piezoelectric sensors induced by a bond front between the first and second substrates during the bonding.

A third aspect of the disclosure provides a bonding system for bonding a first substrate to a second substrate, the system comprising: at least one stage including a base, a vacuum chuck, and a plurality of piezoelectric sensors positioned between the vacuum chuck and the base for measuring a force change induced by a bond front between the first and second substrates during bonding.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of a bonding system according to one embodiment.

FIG. 2 shows a top view of a plurality of piezoelectric sensors according to one embodiment.

FIGS. 3A-D show one embodiment of a method of bonding including monitoring.

FIG. 4 shows one embodiment of piezoelectric sensors registering a bond front.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

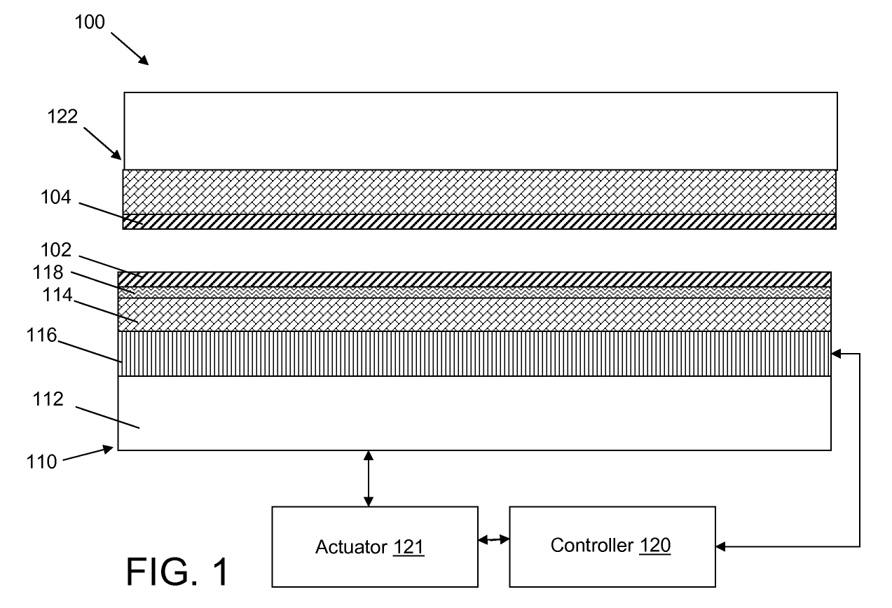

Referring to FIG. 1, embodiments of a bonding system 100 for bonding a first substrate 102 to a second substrate 104 are illustrated. Bonding system 100 includes at least one substrate mounting stage 110 including a base 112, a vacuum chuck 114, and a plurality of piezoelectric sensors 116. Two stages 110, 122 are shown. Base 112 may include any now known or later developed base structure used for a bonding stage, for example, a granite slab. Vacuum chuck 114 may include any now known or later developed structure for mounting and temporarily affixing substrate 102 thereto. For example, vacuum chuck 114 may include a polymer membrane 118 that can be plastically de-formed to correct for any thickness variation or tilt of either of the substrates. In addition, in one embodiment, plurality of piezoelectric sensors 116 are positioned between vacuum chuck 114 and base 112. As will be described in greater detail below, each piezoelectric sensor 116 measures a force change induced by a bond front between first and second substrates 102, 104 during bonding. The bond front is a boundary line (curved or straight) between portions of bonded substrates and portions of un-bonded substrates, or, in other words, the line along which the two substrates' bonding proceeds. The bond front viewed from a top view may vary; for example, it may be substantially circular, off-circular, substantially parallel lines, etc. At least one actuator 121 may be coupled to one or more stages 110,122 for bringing stages 110, 122 together. A control signal to instruct actuator(s) 121 may be provided by controller 120. Although only one stage 110 is shown including piezoelectric sensors 116, the other stage 122 may also include piezoelectric sensors 116.

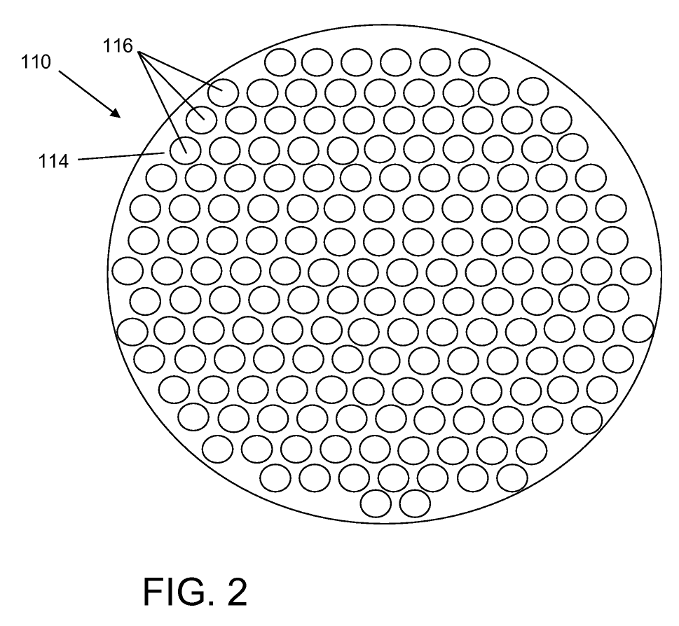

As shown in FIG. 2, in one embodiment, each piezoelectric sensor 116 includes piezo-electric material and electrodes to allow readout of the electrical potential that is generated upon a force change on the piezo-electric material fixedly mounted to vacuum chuck 114 of substrate mounting stage 110, i.e., embedded in substrate mounting stage 110. By embedding piezoelectric sensors 116 in at least one of two substrate mounting stages 110, 122 of bonding system 100, one can measure the force changes induced by the progression of a bond front across a substrate surface. In particular, piezoelectric sensors 116 are mounted to vacuum chuck 114 to enable any force on vacuum chuck 114 to be directly read by the electronics. When there is a change in force on vacuum chuck 114, a voltage on the terminals of a piezoelectric sensor 116 is created, which can be calibrated to quantify the force present on substrate 102. A change in force occurs during the passing of the bond front by piezoelectric sensor 116 location. When a plurality of piezoelectric sensors 116 are strategically distributed over vacuum chuck 114, as shown in FIG. 2, bonding speed and strength and thus bonding quality and uniformity can be monitored by controller 120, and action can be taken to improve the overall result, e.g., by slowing or reversing the progression of the bonding, using piezoelectric actuators to make corrections, etc.

Returning to FIG. 1, bonding system 100 may also include a controller 120 for controlling the bonding. As understood, a conventional controller may control bonding based on and according to a large number of parameters such as temperature, time, bonding force of stages, substrate materials, etc. According to embodiments of the disclosure, controller 120 also controls bonding based on, among others, the force change measured by piezoelectric sensors 116. Controller 120 may include a computing device in the form of any general purpose computing article of manufacture capable of executing computer program code installed by a user (e.g., a personal computer, server, handheld device, etc.). However, it is understood that controller 120 is only representative of various possible equivalent computing devices that may perform the various processes of the disclosure. To this extent, in other embodiments, controller 120 can comprise any specific purpose computing article of manufacture comprising hardware and/or computer program code for performing specific functions, any computing article of manufacture that comprises a combination of specific purpose and general purpose hardware/software, or the like. In each case, the program code and/or hardware can be created using standard programming and engineering techniques, respectively.

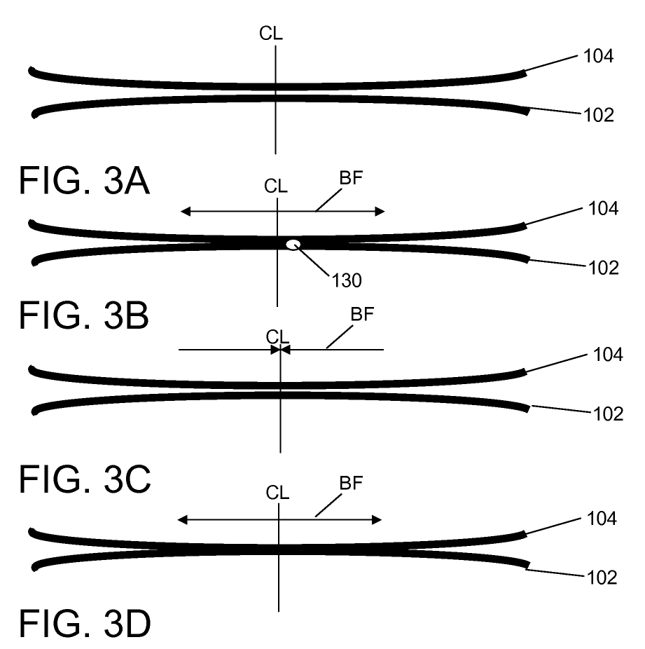

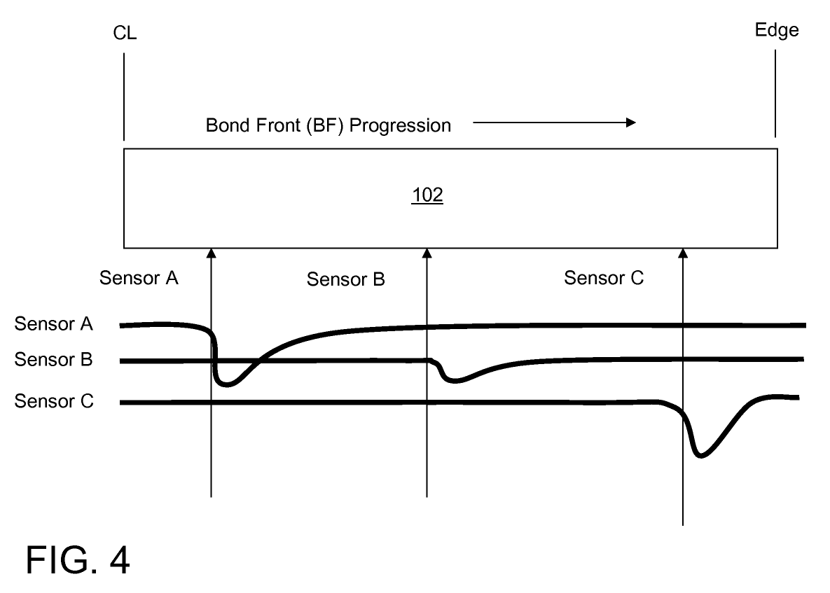

Turning to FIGS. 3A-3D and FIG. 4, embodiments of a method of bonding including monitoring using bonding system 100 (FIGS. 1-2) will now be described. Initially, plurality of piezoelectric sensors 116 are provided on a first substrate mounting stage 110 (FIG. 1) of bonding system 100. Controller 120 calibrates one or more (and preferably all) of piezoelectric sensors 116 by determining a voltage value versus a force sensed. As shown in FIG. 1, first substrate 102 is mounted to first substrate mounting stage 110 and second substrate 104 is mounted to a second substrate mounting stage 122. At this point, controller 120 may determine a baseline force applied by substrate 102 after substrate 102 is coupled to stage 110, i.e., based on the calibration. When substrate 102 is mounted on vacuum chuck 114, a steady-state force will be applied on piezoelectric sensors 116 which will at first create a charge on the terminals of the piezoelectric material. Since there will be dissipation of this charge through the material, the potential will return to neutral after a certain period of time. Accordingly, the determination of the baseline force may occur after a period of time (e.g., a few seconds or minutes) to allow for the dissipation of charge generated by the initial mounting of substrate 102.

FIGS. 3A-3D show bonding first substrate 102 and second substrate 104 while monitoring a force change measured by piezoelectric sensors 116 induced by a bond front (BF) between first and second substrates 102,104 during the bonding. (Note, substrates 102,104 are purposefully bent out of proportion in FIGS. 3A-D to how they actually exist during bonding for clarity of illustration and description.) In FIG. 3A, bonding begins by aligning of center (CL) of each substrate 102, 104 and forcing stages 110, 122 (FIG. 1) towards one another until bonding begins, e.g., using actuator(s) 121 (FIG. 1) under control of controller 120. It is understood, however, that the topography of substrates 102, 104 may not allow bonding to start in center CL, as shown, but at multiple points at the same time. FIG. 3B shows the progression of bonding from center CL outwardly with the bond front (BF) progression shown by arrows, as the stages continue to press substrates 102, 104 together. Referring to FIG. 4, outputs from three piezoelectric sensors A-C are illustrated and compared to bond front progression from a center CL to an edge of substrate 102 (only half shown). As the bonding front BF progresses, an inward most piezoelectric sensor A registers a change in force as it passes, followed by sensor B and then sensor C. Based on this information, controller 120 can determine, among others, a bonding speed and/or a bonding strength.

As also shown in FIG. 3B, an abnormality 130 such as a void has been created between substrates 102, 104, e.g., because of air or dust on one of substrates 102, 104, different coefficient of thermal expansion of materials, or any other of a variety of causes. When bond front BF reaches a piezoelectric sensor 116, e.g., sensor B in FIG. 4, in the vicinity of void 130, a force change is registered by that sensor compared to other sensors. For example, sensor B in FIG. 4 shows a decreased force registration compared to sensor A and sensor C. It is understood, however, that an increase in force may also be an indication of the presence of an abnormality 130. In any event, when an abnormality 130 is detected, controller 120 may take corrective action by adjusting the bonding based on the force change monitored. For example, controller 120 may change the temperature of the bonding, actuate a piezoelectric actuator in stage 110 to adjust the curvature of substrate 102, slow down bond front BF, or make any other bonding parameter adjustment that may impact abnormality 130. FIG. 3C shows one particular example in which controller 120 reverses the bonding, i.e., by having stages 110, 122 move away from one another, to remove abnormality 130, which is followed by continuation of bonding in FIG. 4D without abnormality 130. During or after the reversal, other adjustments may also be made. Note, reversal of bonding may not always be possible.

It is understood that while FIGS. 3A-3D show bonding from a centerline outwardly, that the teachings of the disclosure are not limited to that particular technique. That is, the bonding may progress from an edge and across substrates may also be employed. Furthermore, as noted above, the bond front shown from a top view may vary. For example, it may be substantially circular, off-circular, substantially parallel lines, etc.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person skilled in the art are intended to be included within the scope of the disclosure as defined by the accompanying claims.

What is claimed is:

1. A method of monitoring bonding of a first and second substrate, the method comprising:
providing a plurality of piezoelectric sensors to a substrate mounting stage of a substrate bonding system; and
monitoring a force change measured by the plurality of piezoelectric sensors induced by a bond front between the first and second substrates during bonding.

2. The method of claim 1, wherein the providing includes fixedly mounting the plurality of piezoelectric sensors to a vacuum chuck of the substrate mounting stage.

3. The method of claim 1, wherein the monitoring further comprises determining a baseline force after the substrate is coupled to the stage.

4. The method of claim 3, wherein the determining occurs after a period of time to allow for dissipation of charge generated by an initial mounting of the substrate.

5. The method of claim 1, further comprising calibrating a voltage value versus a force sensed for at least one of the plurality of piezoelectric sensors.

6. The method of claim 1, further comprising determining a bonding speed.

7. The method of claim 1, further comprising determining a bonding strength.

8. A method of bonding a first and second substrate, the method comprising:
providing a plurality of piezoelectric sensors on a first substrate mounting stage of a substrate bonding system;
mounting the first substrate to the first substrate mounting stage and the second substrate to a second substrate mounting stage; and
bonding the first and second substrates while monitoring a force change measured by the plurality of piezoelectric sensors induced by a bond front between the first and second substrates during the bonding.

9. The method of claim 8, wherein the providing includes fixedly mounting the plurality of piezoelectric sensors to a vacuum chuck of the substrate mounting stage.

10. The method of claim 8, wherein the monitoring further comprises determining a baseline force after the substrate is coupled to the stage.

11. The method of claim 10, wherein the determining occurs after a period of time to allow for dissipation of charge generated by an initial mounting of the substrate.

12. The method of claim 8, further comprising calibrating a voltage value versus a force sensed for at least one of the plurality of piezoelectric sensors.

13. The method of claim 8, further comprising determining at least one of a bonding speed and a bonding strength.

14. The method of claim 8, further comprising adjusting the bonding based on the force change monitoring.

15. A bonding system for bonding a first substrate to a second substrate, the system comprising:
at least one stage including a base, a vacuum chuck, and a plurality of piezoelectric sensors positioned between the vacuum chuck and the base for measuring a force change induced by a bond front between the first and second substrates during bonding.

16. The bonding system of claim 15, further comprising a controller for controlling the bonding based on the force change measured.

17. The bonding system of claim 16, wherein the controller determines a baseline force after a substrate is coupled to the at least one stage.

18. The bonding system of claim 17, wherein the determining occurs after a period of time to allow for dissipation of charge generated by an initial mounting of the substrate.

19. The bonding system of claim 16, wherein the controller calibrates a voltage value versus a force sensed for at least one of the plurality of piezoelectric sensors.

20. The bonding system of claim 16, wherein the controller determines at least one of a bonding speed and a bonding strength.
